(19) United States
(12) Patent Application Publication
(10) Pub. No.: US 2022/0274358 A1
(43) Pub. Date: Sep. 1, 2022

(54) STIFFENER FREE LIGHTWEIGHT COMPOSITE PANELS

(71) Applicant: UNM Rainforest Innovations, Albuquerque, NM (US)

(72) Inventors: Mahmoud Reda Taha, Albuquerque, NM (US); Arafat Khan, Albuquerque, NM (US); Eslam Mohamed Soliman, Albuquerque, NM (US)

(73) Assignee: UNM Rainforest Innovations, Albuquerque, NM (US)

(21) Appl. No.: 17/749,835

(22) Filed: May 20, 2022

Related U.S. Application Data
(62) Division of application No. 16/494,723, filed on Sep. 16, 2019.
(60) Provisional application No. 62/471,178, filed on Mar. 14, 2017.

(51) Int. Cl. B29C 70/88; C01B 32/158; B82Y 30/00

(52) U.S. Cl. CPC B29C 70/887; C01B 32/158; B82Y 30/00; B33Y 80/00

(57) ABSTRACT

A panel comprising internal strips or regions reinforced with nanomaterials having high load carrying capacity.

### RELATED APPLICATIONS

This application is a divisional of U.S. Ser. No. 16/494,723 filed on Sep. 16, 2019, which is a 371 U.S. National Phase of PCT/US2018/022472, which claims the benefit of U.S. Provisional Application No. 62/471,178 filed Mar. 14, 2017, all of which are herein incorporated by reference.

### BACKGROUND OF THE INVENTION

Composite materials are the most commonly used materials in modern aerospace, naval or automotive industries. They are also used today in civil structures. One of the most common structural elements used in automotive, naval and aerospace industries are composite stiffened panels. The extensive use of these stiffeners in modern day aircraft is mainly motivated by their high efficiency in terms of stiffness and strength to weight ratios. Stiffened composite panels are widely used in aircraft fuselages, ship hulls, in helicopter tails, in automotive industries, and in composite elements in civil infrastructure. Many researchers over the years have conducted research for optimum design, and implementation of composite stiffened panels. Researchers focused their attention on understanding the failure mechanisms causing panel collapse and in experimentally investigating the interaction between the panel skin and the stiffeners. Overall various studies were performed in last three decades to either mechanically improve the design or optimize theses kind of structures for different applications.

Stiffener plates, always stitched to composite panels, are necessary structural elements for preventing shear buckling. Although the vast application of stiffened panels is found in the literature and field applications, they have certain disadvantages in design. Debonding behavior of the stiffeners from the plate and delamination under large strain deformations are the two most common failure modes of any structure. In addition to being difficult to attach and being a source of composite failure, stiffener plates represent additional weight and limits the composite use. FIG. 1 shows stiffener plates attached to the composite panel as used in various structures (stiffeners) used for aerospace applications.

### BRIEF SUMMARY OF THE INVENTION

In one embodiment, the present invention provides structural composites that may be used in civil, automotive and aerospace applications where the weight of composite panels is a fundamental issue, and potential inhibition against use, governing their use in these applications.

In another embodiment, the present invention eliminates the need to fasten, affix, or stitch stiffener plates to panels or composite panels to provide structural elements for preventing shear buckling.

In another embodiment, the present invention eliminates the need and use of stiffener plates and other stiffening elements in panels or composite panels by providing surface grown nanomaterials and/or 3D printing technology. This eliminates the need to attach stiffeners to a panel, which are weak points that initiate composite failure, and represent additional weight that limits the use of composites.

In another embodiment, the present invention provides a stiff nanomaterial grown or 3D printed at the location of a stiffener and that provides the same or higher load capacity of the panels or composite panel.

In other embodiments, the present invention is not limited to stiffener plates. It is applicable to load sharing and stiffening elements or regions which may benefit from stiffened strips or regions. They are created using nanotechnology and/or 3D printing. The embodiments of the present invention enable creating a new generation of structural composites/elements that are light weight, stable without need for stiffening and much more versatile for numerous applications.

In other embodiments, the present invention provides stiffener free panels or composite panels using internal strips reinforced with nanomaterials and fabricated using surface grown nanostructures and/or 3D printing with high load bearing capacity.

In other embodiments, the present invention provides stiffened strips that may be as thin as 100 micrometers and its stiffness can be controlled during fabrication by selecting the stiffness of the material to be grafted and the density of grafting.

In other embodiments, the present invention provides for the creation of stiffener free panels or composite panels.

In other embodiments, the present invention provides for the creation of load-guided composite panels by designing load-paths with a pre-designed stiffness that is distributed across the panel or composite panel to enable specific ultimate load carrying capacity or to limit the maximum deformations to take place in the panel.

In other embodiments, the present invention provides stiffener free panels or composite panels having a forest of nanomaterials such as carbon nanotubes with significantly high stiffness grown at the surface.

In other embodiments, the present invention provides stiffener free panels or composite panels having a strip of highly aligned nanomaterials surface grown or 3D printed.

In other embodiments, the invention covers all types of composite materials including but not limited to composites with natural, synthetic, continuous, and discontinuous fibers and with polymeric, ceramic, and metallic matrices.

In other embodiments, the invention covers panels or composite panels with different geometries including but not limited to flat, curved and cylindrical panels.

In other embodiments, the present invention provides stiffener free panels or composite panels having at least one thin strip of highly aligned nanomaterials.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIGS. 1A-1B illustrate a composite plate with stiffeners attached to the composite panel.

FIGS. 2A, 2B, 2C-2D illustrate a forest of nanomaterial constructed using 3D printing technology for an embodiment of the present invention.

FIG. 3 is a schematic of the stiffener free composite panel with a strip of highly aligned nanomaterials for an embodiment of the present invention.

FIGS. 4A, 4B, 4C and 4D show a buckling analysis of composite plate in shear loading: (a) ABAQUS model used, (b) Buckling mode and load for a plate with no stiffener, (c) Buckling load and mode for plate with out-of-plane stiffener, and (d) Buckling load and mode for plate with nanomaterial (no stiffener).

FIG. 5 illustrates a variation of buckling load with changing width of the nanomaterial strip in the plate.

FIG. 6 illustrates a buckling load variation with increasing stiffness for nanomaterial for nanomaterial strip width of 0.8 mm (=800 micrometers).

FIG. 7 shows the effect of significantly widening the high stiff nanomaterial strip on the buckling load for the composite panel.

FIG. 8 is RVE unit cells for schematics for homogenization approach to determine stiffness of the nanomaterial.

FIGS. 9A, 9B and 9C illustrates (i) Unit cell array shown for the RVE; (ii) dimension of the unit cell consisting epoxy and nano-pillar; (iii) RVE unit cell cube shown for modeling in ABAQUS.

FIG. 10 illustrates a boundary conditions shown in the unit cell RVE for the effective stress σₓ.

FIG. 11 illustrates a buckling analysis of the composite plain weave lamina using the stiffness determined from the unit cell analysis.

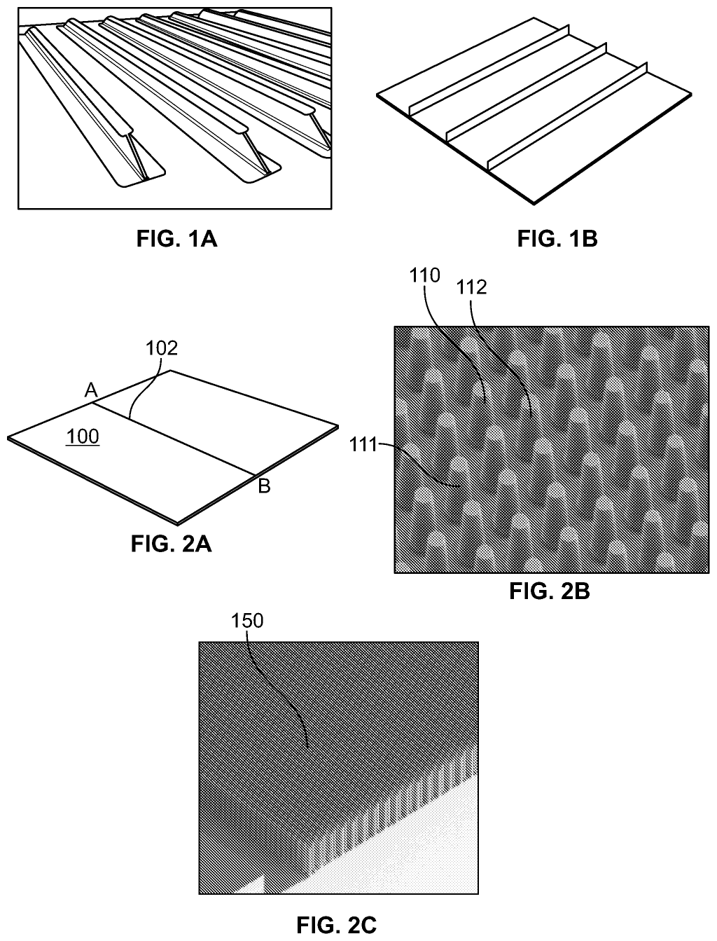

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention. As used herein panel means any substrate or material that may be subject to one or more failure mechanisms causing collapse. A panel may also be made of metallic/no-metallic material, combinations and composites thereof. Panels also include composite panels including panels made of composite materials including but not limited to composites with natural, synthetic, continuous, and discontinuous fibers and with polymeric, ceramic, and metallic matrices

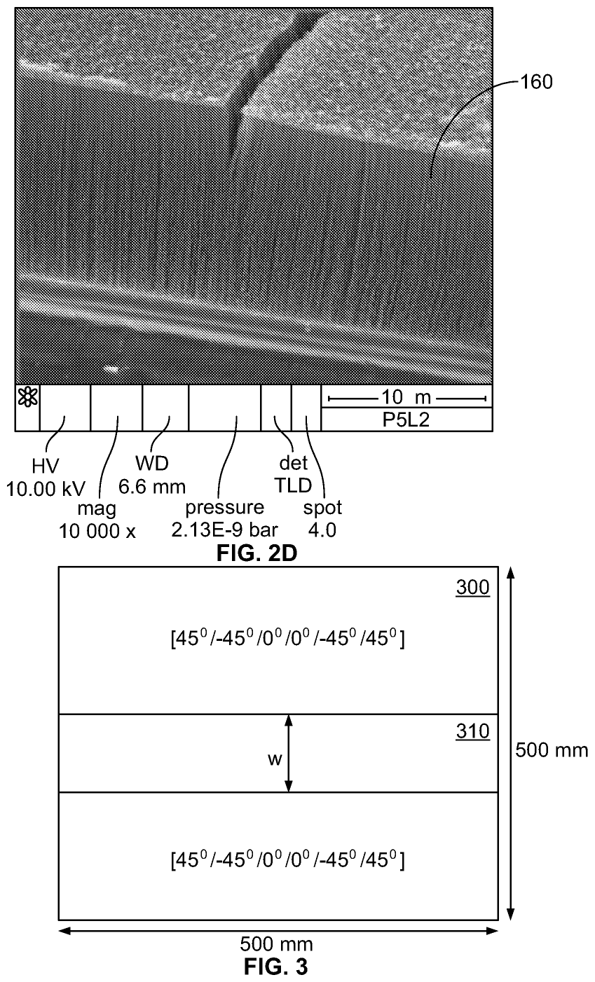

FIGS. 2A-2D illustrate a forest of nanomaterial constructed using 3D printing technology for an embodiment of the present invention. As shown in FIG. 2A, panel 100 may include at least one stiffener 102. As shown in FIGS. 2B-2D, stiffener 102 may include 3D-printed structures such as micro-pillars 110-112 arranged to form a strip 150. In other embodiments, as shown in FIG. 2D, stiffener 102 may be comprised of grown materials such as single walled and multi-walled carbon nanotubes 160. In other embodiments, a mixture of printed structures and grown materials may be used. In yet other embodiments, the stiffeners may be made of deposited materials.

In a preferred embodiment, the physical aspect the tubes of nanomaterials can be grown as a forest of nanomaterials as shown in FIGS. 2A-2D which will avoid the use of stiffeners on a composite panel under shear loading. The proposed stiffness of the nanomaterial will be possible by aligned growth of carbon nanotubes and/or 3D printing technology with relatively stiff nanomaterials.

In yet other embodiments, the present invention is not limited to stiffener plates but to other stiffening elements where stiffened strips are created using nanotechnology and 3D printing that create structural composites. The structural components may be light weight and much more versatile for numerous structural applications.

### Buckling of Stiffened Panels

One of the most common modes of failure in a stiffened panel occurs due to buckling under shear or compression type of loading. The buckling mode and the buckling load for a 500-mm square composite panel under shear loading was investigated. As shown in FIG. 3, plate 300 is a plain weave lamina of six plies with a total thickness of the plate being 4.2 mm. A 50 mm high stiffener is attached at the middle of the plate. The buckling analysis of the composite stiffened plate was studied under applied shear force. Commercial finite element software ABAQUS was used to simulate the buckling behavior. After the buckling behavior of the stiffened plate was simulated, the stiffener was replaced by high stiff orthotropic material 310 with region width of was shown in FIG. 3.

### Finite Element Modeling

The Finite Element (FE) model for the buckling analysis was performed in ABAQUS. The plate was modeled using S4 elements by the combination of the “composite layup” feature to define the laminate stacking sequence of the plain weave laminate. The stiffness matrix of the plate can be described by Equation (1)

$$[ \begin{matrix}{D}_{1111} & {D}_{1122} & {D}_{1133} & 0 & 0 & 0 \\ {D}_{1122} & {D}_{2222} & {D}_{2233} & 0 & 0 & 0 \\ {D}_{1133} & {D}_{2233} & {D}_{3333} & 0 & 0 & 0 \\ 0 & 0 & 0 & {D}_{1212} & 0 & 0 \\ 0 & 0 & 0 & 0 & {D}_{1313} & 0 \\ 0 & 0 & 0 & 0 & 0 & {D}_{2323}\end{matrix} ] \qquad ( 1 )$$

The stiffener was removed and replaced by a composite strip 310 representing polymer matrix reinforced with nanomaterial grown or 3D printed as shown in FIGS. 2B-2D. Orthotropic material properties are defined in the region replaced by nano-material by:

E₁=rₘE₁^{o}, E₂=rₘE₂^{o}, E₃=10rₘE₃^{o} (2)

Where material orthotropy is given by:

$${D}_{1111} = γ {E}_{1} ( 1 - {v}_{23} {v}_{32} ) \qquad ( 3 )$$

$${D}_{1122} = γ {E}_{2} ( {v}_{12} + {v}_{32} {v}_{13} ) \qquad ( 4 )$$

$${D}_{2222} = γ {E}_{2} ( 1 - {v}_{13} {v}_{31} ) \qquad ( 5 )$$

$${D}_{1133} = γ {E}_{3} ( {v}_{13} + {v}_{12} {v}_{23} ) \qquad ( 6 )$$

$${D}_{2233} = γ {E}_{3} ( {v}_{23} + {v}_{21} {v}_{13} ) \qquad ( 7 )$$

$${D}_{3333} = γ {E}_{3} ( 1 - {v}_{12} {v}_{21} ) \qquad ( 8 )$$

$${D}_{1212} = {G}_{12} \qquad ( 9 )$$

$${D}_{1313} = {G}_{13} \qquad ( 10 )$$

$${D}_{2323} = {G}_{23} \qquad ( 11 )$$

$$γ = \frac{1}{1 - {v}_{21} {v}_{12} - {v}_{23} {v}_{32} - {v}_{31} {v}_{13} - 2 {v}_{21} {v}_{32} {v}_{13}} \qquad ( 12 )$$

In Eq. (2) rₘ is a multiplier used to numerically define the stiffness value in the out of plane direction. The stiffness component in the out-of-plane direction (E3), is considered to be an order of magnitude (10 times) higher than the longitudinal and the transverse plate stiffness. This can be achieved by using aligned nanotubes grown uniformly in the out-of-plane direction.

### FEA Model Verification

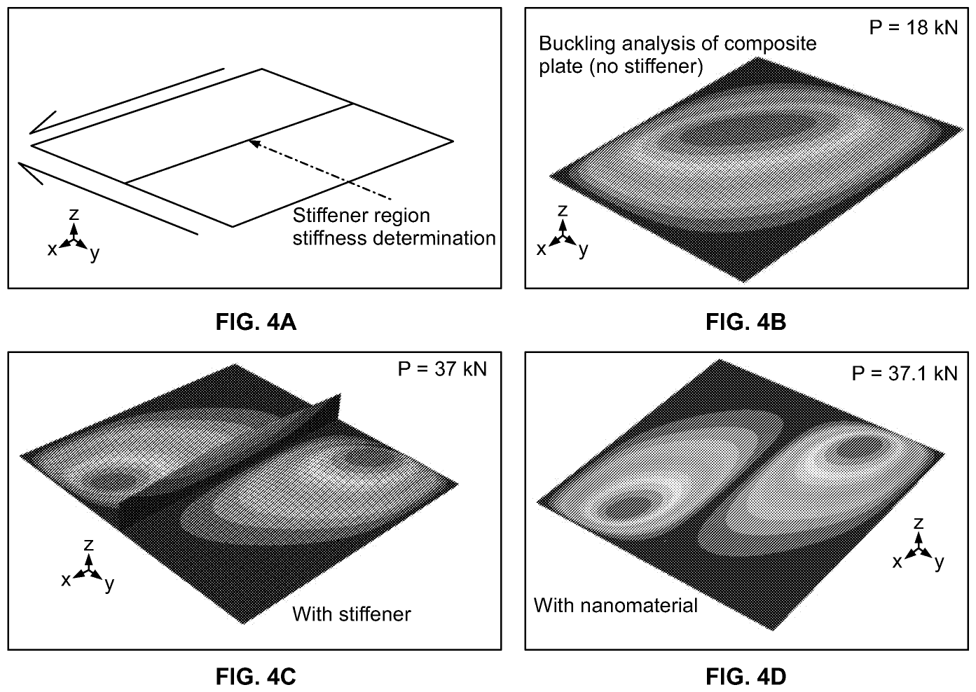

FIG. 4(a) shows the ABAQUS model used for the buckling analysis. FIG. 4(b) shows buckling load (18 kN) and the buckling mode for plate 300 without any stiffener. FIGS. 4(c) and (d) show buckling loads and buckling modes for the plate with stiffener (37.0 kN) and the plate with nanomaterial (37.1 kN) by eliminating the stiffeners.

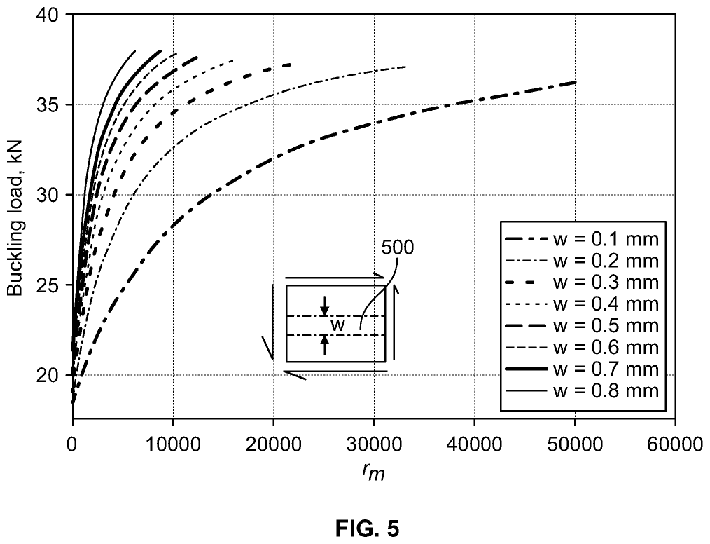

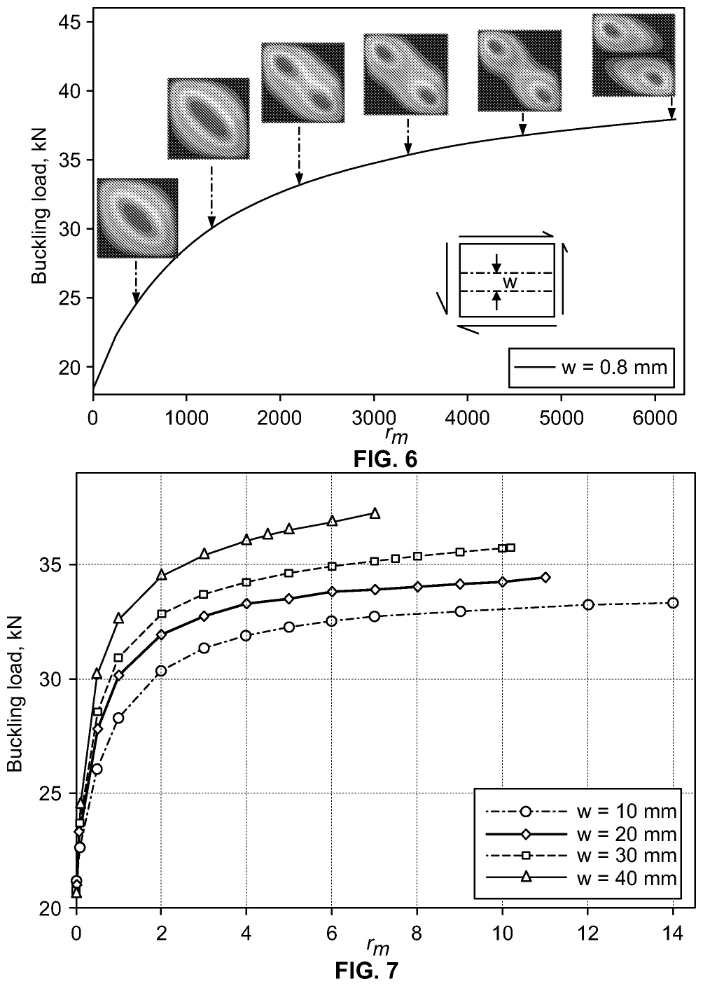

The stiffener was replaced by the above described highly aligned and stiff nanomaterials. The stiffener panel was removed by inserting the nanomaterial in region 500n of specified by the width w as shown schematically in FIG. 5. FIG. 5 shows a study of the variation of the width of this region with the buckling load of the panel. FIG. 6 shows the variation of the buckling load for a width of 0.8 mm where the stiffener was replaced by the nanomaterials.

A parametric investigation was conducted to examine the effect of the width of the nano-strip on buckling behavior. FIG. 5 shows the variation of the buckling load for varying width, w with increasing value of stiffness multiplier rₘ. The values of the w were chosen arbitrarily for the parametric study. The idea is to optimize the width region to a minimum by maintaining similar buckling mode. This idea is more clearly depicted in FIG. 6, where for a w=0.8, the stiffness coefficient rₘ converges to value where we obtain the intended buckling mode for the plate without any stiffener. A further parametric study was performed by considering much wider strip to obtain a converged value of the rₘ as shown in FIG. 7. The stiffness multiplier rₘ can be significantly reduced when a relatively wider “w” is used. A very narrow strip results in very high stiffness multiplier that is unrealistic to practically produce.

### Determination of Stiffness

To justify the stiffness in the region where the nanomaterial is being applied, a 3D homogenization technique was implemented in ABAQUS. A unit cell (Representative Volumetric Element, RVE) was created and certain strain cases were applied to the model to solve backward for the homogenized properties of the unit cell. The unit cell consists of highly stiff cylindrical pillars of nanomaterial surrounded by epoxy material. FIG. 8 shows the schematic of the configuration of the unit cell RVE under six different loading conditions. The homogenization technique provides the stiffness properties to be incorporated in the nanomaterial region of the composite plate for the buckling analysis. From the displacement applied for six-unit cell models, the stiffness was calculated using the reaction force of each model. This showed that the modulus of the nano-pillars mostly contributes to the stiffness of the nano strip that controls the buckling effect in the composite plate.

### 3D Homogenization of Unit Cell

The homogenization approach may be used to determine the material constituent of orthotropic material system. The homogenization approach will result in determining the input of the stiffness that is provided to the nano-strip (stiffener region) region in ABAQUS as an orthotropic material system. The stiffness of an isotropic unit cell RVE is given by:

$$[ \begin{matrix}{C}_{11} & {C}_{12} & {C}_{12} & 0 & 0 & 0 \\ {C}_{12} & {C}_{11} & {C}_{12} & 0 & 0 & 0 \\ {C}_{12} & {C}_{12} & {C}_{11} & 0 & 0 & 0 \\ 0 & 0 & 0 & {C}_{44} & 0 & 0 \\ 0 & 0 & 0 & 0 & {C}_{44} & 0 \\ 0 & 0 & 0 & 0 & 0 & {C}_{44}\end{matrix} ] \qquad ( 13 )$$

$$Where$$

$${C}_{11} = \frac{( 1 - v ) E}{( 1 + v ) ( 1 - 2 v )} , {C}_{12} = \frac{vE}{( 1 + v )} , {C}_{44} = \frac{E}{2 ( 1 + v )} \qquad ( 14 )$$

Where E is the effective modulus of the unit cell and v is the Poisson's ration of the isotropic epoxy and the nano-pillar, which is assumed to be constant at 0.3. Assuming the unit cell consists of isotopic epoxy material and isotropic highly stiff nanomaterial, we can determine the constituents C₁₁, C₁₂, and C₄₄ of Eq. (14). The RVE unit cell modeled in ABAQUS is shown in FIG. 8. The RVE unit cell is a cube of 30 nm with the diameter of the nano-pillar is being 27 nm with the ratio of b/a being 0.9.

The isotropic unit cell is subjected to uniaxial displacement to produce an axial strain which satisfies the Hooke's law conditions to result in C₁₁, C₁₂, and C₄₄ being:

$${σ}_{x} = {C}_{11} = \frac{( 1 - v ) E}{( 1 + v ) ( 1 - 2 v )} , \\ {σ}_{y} = {C}_{12} = \frac{vE}{( 1 + v )} = {σ}_{z} , \\ G = {C}_{44} = \frac{E}{2 ( 1 + v )} \qquad ( 15 )$$

Thus, the constitutive matrix can be written in terms of the effective stress on unit cell as:

$$[ \begin{matrix}{σ}_{x} & {σ}_{y} & {σ}_{y} & 0 & 0 & 0 \\ {σ}_{y} & {σ}_{x} & {σ}_{y} & 0 & 0 & 0 \\ {σ}_{y} & {σ}_{y} & {σ}_{x} & 0 & 0 & 0 \\ 0 & 0 & 0 & G & 0 & 0 \\ 0 & 0 & 0 & 0 & G & 0 \\ 0 & 0 & 0 & 0 & 0 & G\end{matrix} ] \qquad ( 16 )$$

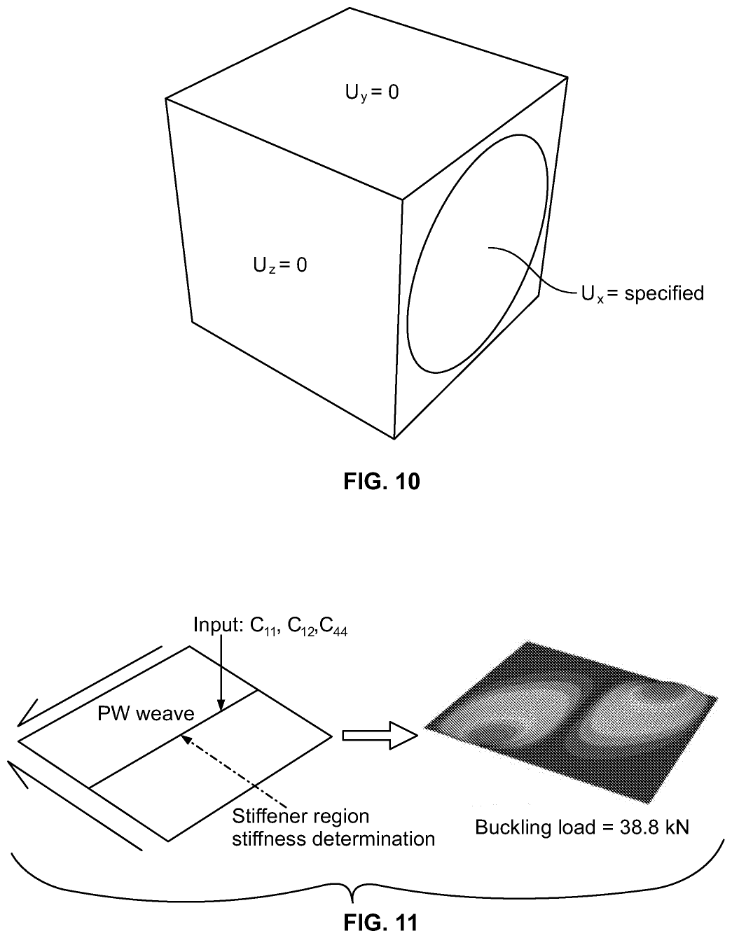

The effective stresses are computed by solving for the reaction forces of the unit cell and are given by:

$${σ}_{x} = \frac{( 1 - v ) P}{A {ε}_{x} ( 1 + v ) ( 1 - 2 v )} \qquad ( 17 )$$

$${σ}_{y} = \frac{vP}{A {ε}_{y} ( 1 + v ) ( 1 - 2 v )} \qquad ( 18 )$$

Where A is the surface area of the reaction force and the P is the reaction force of the loaded face of the unit cell. The boundary condition for one of the unit cell simulations is shown in FIG. 10.

### Buckling Analysis with Unit Cell Stiffness

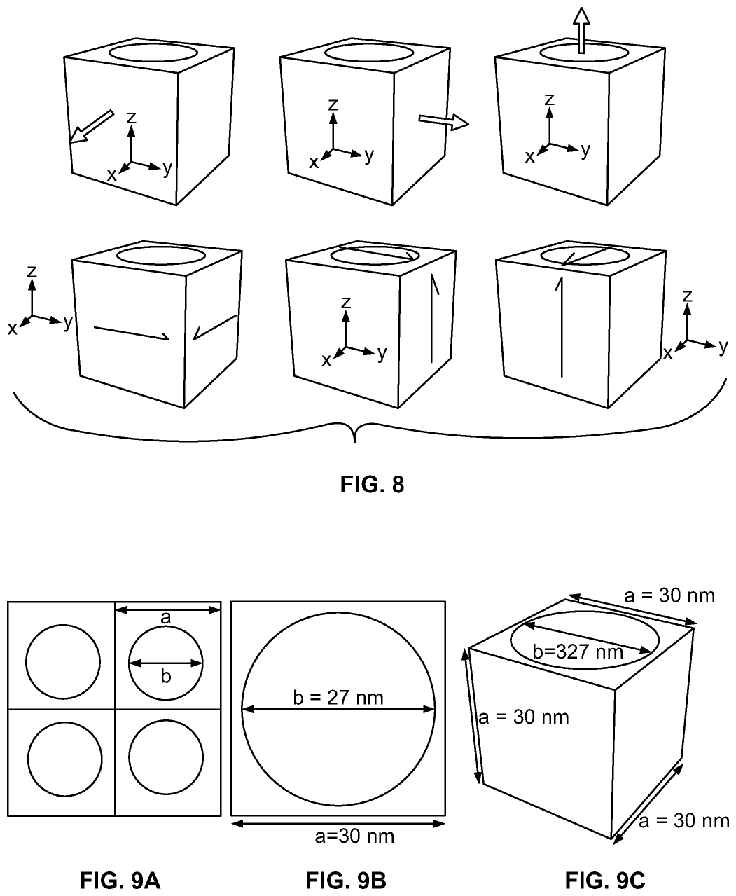

The stiffness coefficients, C₁₁, C₁₂, and C₄₄ determined from the unit cell analysis is used as the orthotropic material input to describe the stiffness of the nano-strip to perform the buckling analysis of the panel under pure shear loading. The unit cell analysis was performed for the stiffness of the nono-pillar being 3000 GPa (3 TPa) for the dimension of the RVE unit cell shown in FIG. 9 (iii). FIG. 11 shows the buckling mode obtained using stiffness of 3000 GPa. The orthotropic material properties are inserted based on Eq. (13). Typically, nanotubes have stiffness of about 1000 GPa (1 TPa) so the simulated values are within practical reach.

In other embodiments, the present invention provides one or more nanocomposite strips incorporating vertically aligned carbon nanotubes or 3D printed micro-pillars embedded in a polymer matrix to create a nano-stiffened strip.

For some embodiments, the stiffness is produced using aligned surface growth of carbon nanotubes and/or 3D printing technology using a metal stiffened colloid polymer. The resulting panel is much lighter than the original panel but with the same load carrying capacity.

Stiffeners that may be used with the present invention include posts, pillars, columns, and other structures or features that raise up from the panel in the vertical direction. The vertical raised features may also be formed in periodic or random patterns and structures.

In other embodiments, a substrate and the reinforcing features described above may be formed into a composite designed with load-paths with pre-designed stiffness that are distributed across the composite to enable specific ultimate load capacity or to limit deformations. The load paths may include one or more posts, pillars, columns, or other structures or features that raise up from the composite.

The features of the composite may also be formed in periodic or random patterns and structures. In yet other embodiments, a stiffener free composite panel comprising internal strips or regions reinforced with nanomaterials may be fabricated using surface grown nanostructures and/or 3D printing with high load carrying capacity. The panel may be as thin as 100 micrometers and its stiffness can be controlled during fabrication by selecting the stiffness of the material to be grafted and the density of grafting.

In still further embodiments, the present invention provides a stiffener free composite panel designed with load-paths with pre-designed stiffness that are distributed across the composite panel to enable specific ultimate load capacity or to limit deformations. The load paths may include one or more posts, pillars, columns, or other structures or features that raise up from the panel or grow in the out-of-plane direction. The raised features may also be formed in periodic or random patterns and structures.

In other embodiments, the composite is designed with load-paths with pre-designed stiffness that are distributed across the composite to enable specific ultimate load carrying capacity or to limit deformations.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiments, methods, and examples, but by all embodiments and methods within the scope and spirit of the disclosure.

1. (canceled)

2. (canceled)

3. (canceled)

4. A panel designed with load-paths with a pre-designed stiffness, said load paths are distributed across the panel to enable specific ultimate load capacity or to limit deformations.

5. The panel of claim 4 wherein said load paths include one or more posts, pillars, columns, or other structures or features that raise up from the panel.

6. The panel of claim 5 wherein said raised features are arranged in periodic patterns.

7. The panel of claim 5 wherein said raised features are arranged in random patterns.

8. (canceled)

9. (canceled)

10. (canceled)

11. (canceled)

12. (canceled)

13. (canceled)

14. (canceled)
